(19) United States
(12) Patent Application Publication
(10) Pub. No.: US 2014/0177167 A1
(43) Pub. Date: Jun. 26, 2014

(54) HEAT DISSIPATION DEVICE

(71) Applicants: HONG FU JIN PRECISION INDUSTRY (ShenZhen) CO., LTD., (US); HON HAI PRECISION INDUSTRY CO., LTD., New Taipei (TW)

(72) Inventor: XIAN-XIU TANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (TW)

(21) Appl. No.: 13/771,030

(22) Filed: Feb. 19, 2013

(30) Foreign Application Priority Data
Dec. 26, 2012 (CN) 201210572966.3

(51) Int. Cl. G06F 1/20

(52) U.S. Cl. CPC G06F 1/20
USPC 361/679.54

(57) ABSTRACT

A heat dissipation device includes a heat sink and an air duct mounted to the heat sink. The heat sink includes a board and a number of fins extending up from the board. The air duct includes an installation piece pivotably mounted to a side of the heat sink, and a blocking piece extending substantially perpendicularly out from an end of the installation piece.

### BACKGROUND

1. Technical Field

The present disclosure relates to a heat dissipation device.

2. Description of Related Art

Air flowing toward central processing units (CPUs) is often partially blown toward memory slots positioned adjacent to the CPUs, which will lower the heat dissipation efficiency for the CPUs.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a heat dissipation device.

FIG. 2 is an assembled, isometric view of FIG. 1, shown in one state.

FIG. 3 is similar to FIG. 2, but shown in another state.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

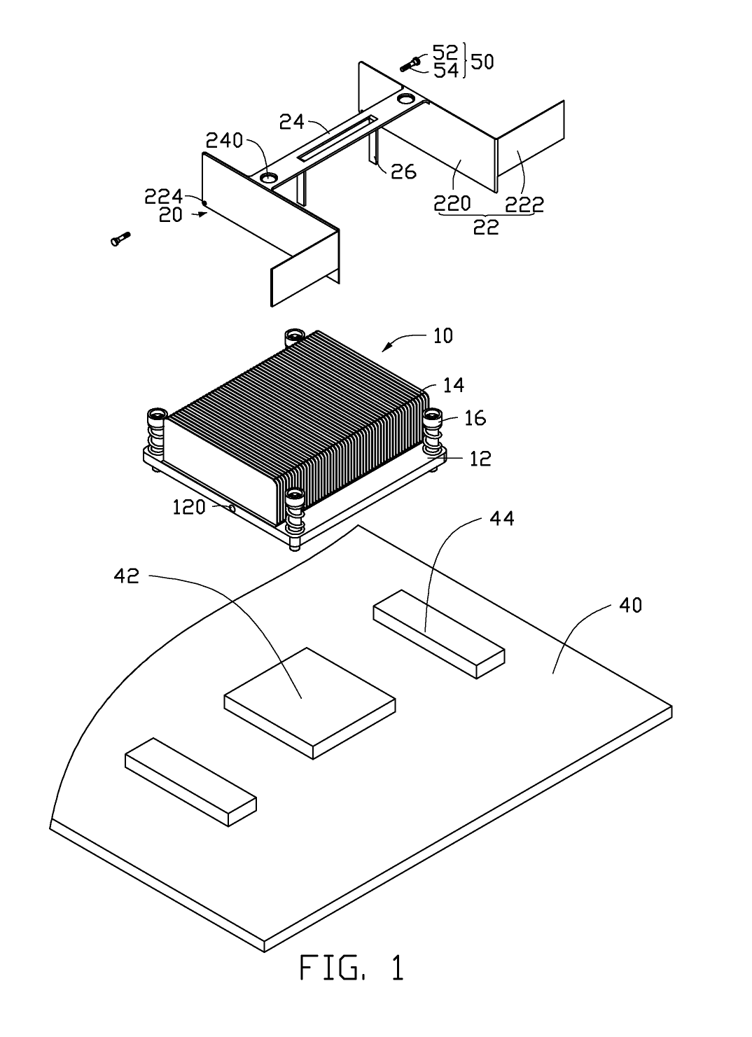

Referring to FIG. 1, an embodiment of a heat dissipation device includes a heat sink 10, an air duct 20, and two screws 50. The heat dissipation device is mounted on a motherboard 40.

A central processing unit (CPU) 42 and two memory slot groups 44 positioned at opposite sides of the CPU 42 are mounted on the motherboard 40.

The heat sink 10 includes a board 12 and a plurality of fins 14 extending up from a top portion of the board 12 in a substantially perpendicular manner. The board 12 defines two threaded holes 120 in opposite sides of the board 12. The board 12 is supported on the CPU 42. Four fasteners 16 extend through four corners of the board 12 to engage in the motherboard 40, thereby fixing the heat sink 10 above the CPU 42.

Each screw 50 includes a head 52 and a threaded pole 54 extending from a side of the head 52.

The air duct 20 includes two opposite L-shaped plates 22, a connecting bar 24 connected between tops of the plates 22, and two supporting bars 26 extending substantially perpendicularly down from the connecting bar 24. Each plate 22 includes an installation piece 220, and a blocking piece 222 extending out from a front end of the installation piece 220 away from the other plate 22 in a substantially perpendicular manner. The connecting bar 24 is connected substantially perpendicularly between tops of the installation pieces 220 of the plates 22. Each installation piece 220 defines a through hole 224 in a lower portion, adjacent to a rear end of the installation piece 220 opposite to the corresponding blocking piece 222. The connecting bar 24 defines at least one installation hole 240 having a greater diameter than the fasteners 16. In one embodiment, there are two installation holes 240.

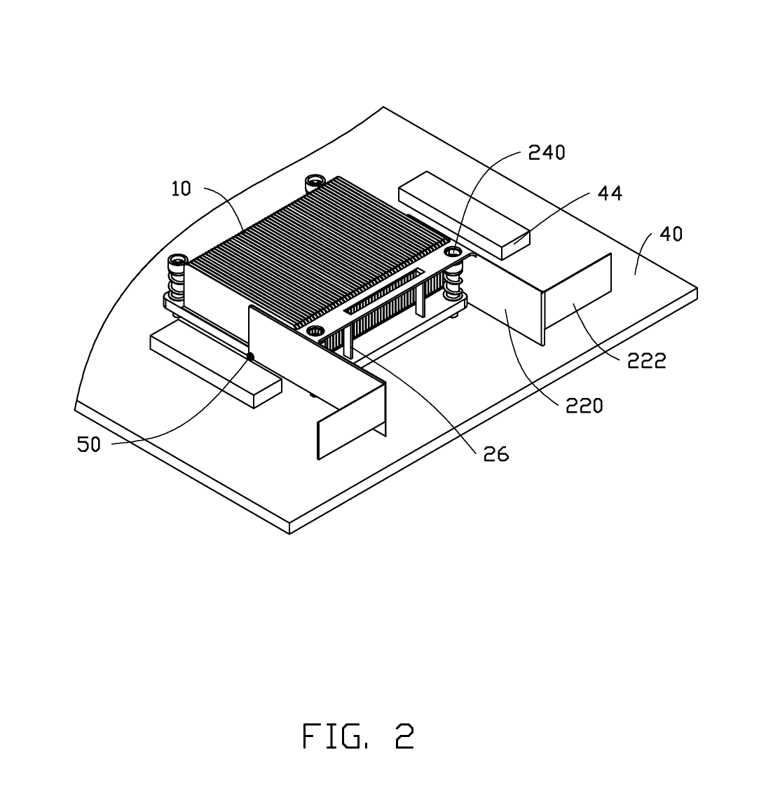

Referring to FIG. 2, in assembly, the air duct 20 is fitted about the heat sink 10, with the installation pieces 22 substantially parallel to the fins 14 and respectively contacting the outmost two fins 14. The connecting bar 24 is positioned before the fins 14. The supporting bars 26 are supported on a front side of the board 12, thereby preventing front ends of the plates 22 from falling. The blocking pieces 222 are located in front of and block the memory slot groups 44. The through holes 224 are aligned with the threaded holes 120. The installation holes 240 are aligned with two fasteners 16, to allow a fastener tool to extend through to fasten or release the fasteners 16. The threaded poles 54 of the screws 50 extend through the through holes 224 to be engaged in the corresponding threaded holes 120, thereby pivotably mounting the air duct 20 to the heat sink 10. The air duct 20 is rotatable about the screws 50

The blocking pieces 222 are blocked by front ends of the memory slot groups 44, to prevent airflow from flowing toward the memory slot groups 44, and guide the airflow toward the heat sink 10 to dissipate heat generated by the CPU 42.

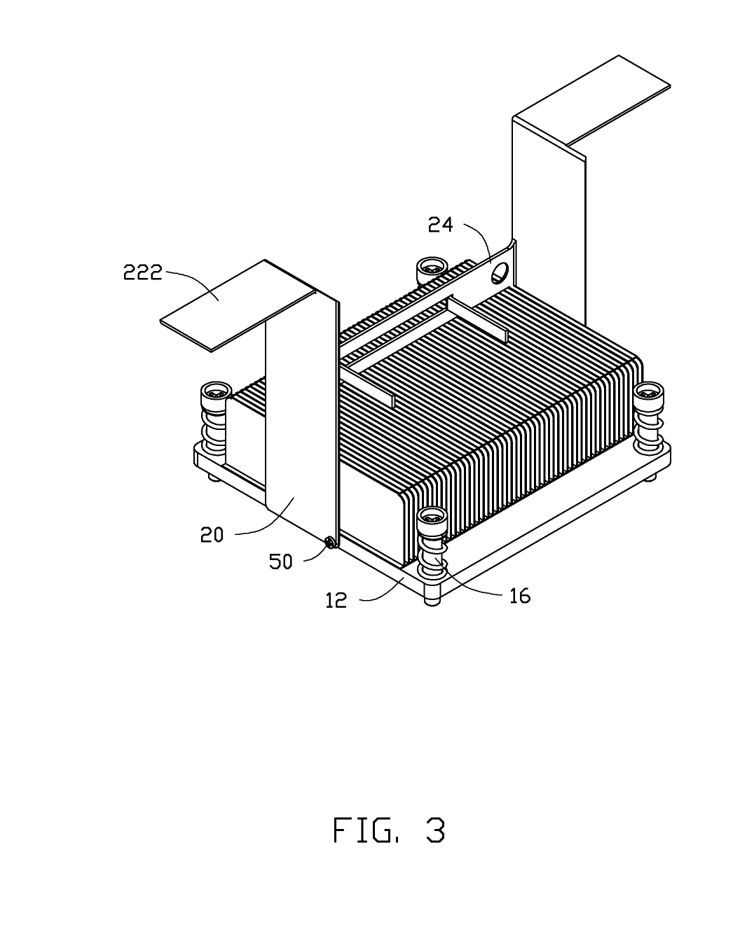

Referring to FIG. 3, in uninstalling the memory slot group 44, the air duct 20 is pivoted rearward about the screws 50, for conveniently disengaging the memory slot group 44 from the motherboard 40.

In another embodiment, the blocking pieces 222 can be slantingly extended from the corresponding installation pieces 22.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A heat dissipation device for dissipating heat generated by a central processing unit (CPU), comprising:
a heat sink mounted above the CPU, the heat sink comprising a board and a plurality of fins extending up from the board; and
an air duct mounted to the heat sink, the air duct comprising a first plate, the first plate comprising an installation piece mounted to a side of the heat sink, and a blocking piece extending out from the installation piece in an angled manner.

2. The heat dissipation device of claim 1, wherein the air duct further comprises a second plate and a connecting bar; the second plate comprising an installation piece mounted to another side of the heat sink, and a blocking piece extending out from the installation piece; the connecting bar connected between tops of the installation pieces of the first and second plates, the blocking pieces of the first and second plates extend away from each other.

3. The heat dissipation device of claim 2, wherein the air duct further comprises a supporting bar extending down from the connecting bar and contacting the board.

4. The heat dissipation device of claim 2, wherein the connecting bar defines two installation holes in opposite ends of the connecting bar.

5. The heat dissipation device of claim 2, wherein ends of the installation pieces of the first and second plates opposite to the corresponding blocking pieces are rotatably mounted to opposite sides of the board.

6. The heat dissipation device of claim 2, wherein the board defines two threaded holes in the opposite sides, the installation pieces each define a through hole, two screws extend through the through holes and engage in the corresponding threaded holes, and the installation pieces are substantially parallel to the fins and contact two outmost fins of the fins.

7. An electronic device, comprising:
a motherboard comprising a first electronic component and a second electronic component located at a side of the first electronic component;
a heat sink comprising a board mounted on the motherboard above the first electronic device, and a plurality of fins extending up from the board; and
an air duct comprising an installation piece mounted to a side of the heat sink and substantially parallel to the plurality of fins, and a blocking piece extending at an angle out from the installation piece, wherein the installation piece is located between the first and second electronic components, and the blocking piece extends away from the heat sink.

8. The electronic device of claim 7, wherein an end of the installation piece away from the blocking piece is pivotably mounted to a side of the board.

9. The electronic device of claim 7, wherein the blocking piece extends substantially perpendicularly from the installation piece.

10. The electronic device of claim 7, wherein the plurality of fins extends substantially perpendicularly from the board.
